(19) United States
(12) Patent Application Publication
(10) Pub. No.: US 2006/0064257 A1
(43) Pub. Date: Mar. 23, 2006

(54) Test device for measuring a container response

(75) Inventors: Garrett Pennington, York, PA (US); Adam Coffman, Dover, PA (US); Greg Trude, Seven Valleys, PA (US); John Tobias, Spartanburg, SC (US); Pat O'Connell, Hershey, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/230,931

(22) Filed: Sep. 21, 2005

Related U.S. Application Data
(60) Provisional application No. 60/611,287, filed on Sep. 21, 2004.

(51) Int. Cl. G01F 23/00; G01K 1/14

(52) U.S. Cl. 702/50; 374/143

(57) ABSTRACT

A test device can acquire interior temperature, interior pressure, and interior volume data on a container exposed to conditions in a test throughout the test and can be used with a computer system.

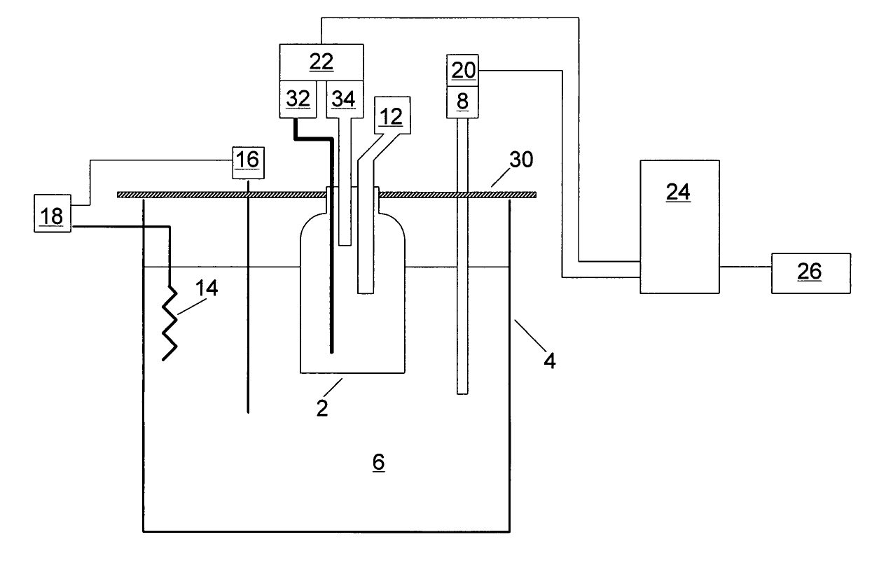

### BACKGROUND OF THE INVENTION

1. Field of the Invention

The present invention relates to a test device for measuring the response of a container to imposed conditions, such as changes in temperature and pressure.

2. Description of the Related Art

In packaging processes, for example, food packaging processes, a container may be filled with a hot material, e.g., a hot beverage. The container is then sealed. When the beverage cools to room temperature, the internal pressure within the container decreases. If the container is not properly designed, the differential between the internal pressure within the container and the ambient pressure around the container can result in deformation of the container. In other processes, a material may be filled into a container and a differential between the internal pressure within the container and the ambient pressure around the container imposed before the container is sealed. Alternatively, air or a product, for example, a liquid product, may be removed from the container and replaced with a gas, such as nitrogen, before sealing the container. The continuous or intermittent low pressure inside the container resulting from these processes can result in deformation of the container.

In designing a container for an application, for example, a food packaging process, an initial prototype container can be made from an initial design. The prototype can be tested by subjecting it to conditions resembling those the container will be exposed to in use. If the container substantially retains its form during the process, the initial design may be found suitable and used in the production of containers. On the other hand, if the container deforms, the bottle designer can assess the nature of the deformation and draw on his or her experience to modify the initial design. A subsequent prototype can then be made and tested. The method of testing a prototype, modifying the design, and making a new prototype is continued until a design for a container which does not deform is obtained. An inexpensive device that can be used to rapidly obtain information on the response of a prototype container to test conditions resembling those to which the container will be exposed in commercial use would reduce the expense of and the time associated with the container design process and be useful in the container manufacturing industry.

In the conventional process of designing a container, if a prototype container is tested under conditions resembling those the container will be exposed to in use and deforms or otherwise fails, the designer modifies the container design so that a new prototype container can be made and tested. To make a new prototype, a new mold must be designed and manufactured, which is time consuming and expensive. Several prototypes may need to be made during the course of designing a new container, and the making of the prototypes can represent a large fraction of the cost of and delay the successful design of a new container. The cost of the design of a new container is passed on to the customer, and thus may hamper a container manufacturer's competitiveness. Furthermore, the ability of a manufacturer to respond quickly to a customer's needs may be impeded.

Incorporating computer simulation in design methodologies can speed up and reduce the expense of designing a new container. For example, a simulation based on finite element analysis can be used to predict the deformation of a container to an interior pressure change. A designer can study the simulation to identify, for example, regions of the container wall that experience stress concentration and require reinforcement. A designer can also create a new container design and simulate the response of the container design to conditions resembling those to which the container will be exposed in use. If the simulation predicts that the container response will be acceptable, for example, by exhibiting deformation within an allowed specification, a blow mold can be constructed and an actual prototype made and tested. On the other hand, if the simulation predicts that the container response will be unacceptable, the time and expense of constructing a mold for making a prototype which would fail under testing can be spared, and the designer can try a different container design.

However, in order for a computer simulation to be useful in reducing the expense of and speeding the development of a new container, the simulation must be accurate. In order to ensure an accurate simulation, accurate data on the dimensions of a container and mechanical properties of the material from which the container is formed are required. The ability to obtain accurate data on the dimensions of a container can be limited, for example, because the thickness of a container wall in regions of the container with tight curves or restrictions can be difficult to measure. The mechanical properties of the material used can also be difficult to determine accurately and completely, especially by a container manufacturer who may not have the specialized measurement devices required.

Therefore, a computer simulation must be validated through comparing the actual response of a container to test conditions to the response of the container predicted by a computer simulation. The actual response can be, for example, a change in interior volume of the container or a change in shape of the container. The test can expose the container to processes and conditions resembling those to which the container will be exposed during actual commercial use, for example, filling with a test substance that is a material such as a food or beverage that is actually filled during a commercial filling process and imposing similar changes in temperature or pressure in the container that occur during a commercial filling process.

Previous test devices have been capable of determining the final interior pressure and interior volume of a container after it has been subjected to a test. Although this small amount of data can confirm or deny the accuracy of a computer simulation, the utility of the data in guiding a designer in modifying the design is limited. For example, how the interior pressure in the container varied during the test remains unknown, impeding the ability of the designer to set up a realistic simulation. The mechanical properties of materials used in containers often depend on temperature; therefore, the absence of data on the variation of temperature in the interior of a container further impedes the setting up of a realistic simulation. Because only the change in interior volume of the container at the end of the test is known, and not throughout the test, the designer's ability to evaluate the simulation is impeded. In addition to hampering the evaluation of a simulation, the limited nature of the data also constrains a designer's ability to identify failure modes of a container during a test and therefore constrains the designer's ability to envision a better design.

To make a useful and more complete comparison of the actual response to the response predicted by a simulation, accurate information on the test conditions to which the container was exposed throughout the test must be obtained and provided to the simulation package. Such test conditions can include, for example, the interior temperature and the interior pressure of the container throughout the test. The actual response of the container throughout the test must be accurately measured. For example, the change in interior volume of the container throughout the test can be measured. Therefore, the test device should be capable of accurately measuring the test conditions, such as interior pressure and interior temperature, and the actual response of a container, for example, the change in interior volume of the container, throughout the test. The task of comparing the actual response to the response simulation can be automated, for example, can be implemented in a computer system, to reduce the time and effort required of the designer.

The designer can use the comparison of the actual response of the container to the test conditions with the response predicted by the computer simulation to manually modify parameters of the simulation, for example, the mesh size used in a finite element analysis routine, in order to improve the accuracy of the simulation. As another example, the designer can introduce correction factors to correct the container parameter data, the test condition data, for example, the interior pressure and interior temperature, or to correct the actual response data, for example, the change in interior volume of the container, to compensate for suspected measurement errors and obtain a more accurate simulation or a more appropriate comparison. Such modified simulation parameters or correction factors can be used in later simulation of tests conducted on different containers under different test conditions to improve the accuracy of such simulations.

However, such manual adjustment of simulation parameters can require that a designer or a designer's colleague be skilled in the art of numerical simulation of physical processes; such skill in numerical simulation may not be present at a container manufacturer. Furthermore, the large number of variables present in the test condition data or container parameter data can render a designer's task of determining which variables to correct and the degree of correction required difficult or impractical. Therefore, it could be useful to have the task of adjusting simulation parameters conducted by a computer system. For example, the computer could apply heuristic or statistical methods to adjust simulation parameters or determine correction factors.

Thus, there exists a need for a test device that can accurately measure test conditions, such as the interior temperature and interior pressure of a container, and accurately measure a container response, for example a change in interior volume of the container, throughout a test. There is further a need for a test device that can provide data in an electronic form to a computer system for data display, reformatting, or storage. There is a need for computer software that can cause a computer system to simulate and predict the response of a container, e.g., the change in interior volume of the container, to a test. There is further a need for computer software that can cause a computer system to compare an actual response of a container, e.g., a change in interior volume, to a predicted response. There is further a need for computer software that can cause a computer system to adjust simulation parameters or correct container parameter data, test condition data, such as interior temperature and interior pressure of a container, or actual response data.

### SUMMARY OF THE INVENTION

It is therefore an object of the present invention to provide a test device that can accurately measure test conditions, such as the interior temperature and interior pressure of a container, and accurately measure a container response, for example a change in interior volume of the container, throughout a test, and can provide data in an electronic form to a computer system for data display, processing, or storage. Another object of the present invention is to provide computer software that can display, reformat, and store data received from a test device. Another object of the present invention is to provide computer software that can cause a computer system to predict the response of a container to a test executed with the test device. Another object of the present invention is to provide computer software that can cause a computer system to compare an actual response of a container to a predicted response. Another object of the present invention is to provide computer software that can cause a computer system to adjust simulation parameters or correct container parameter data, test condition data, or actual response data.

In an embodiment, a test device for a container includes the following: a measurement tower, which is an example of a fluid bath, capable of holding a heat transfer fluid; a displaced volume gauge coupled to the heat transfer fluid in the measurement tower, the displaced volume gauge being an example of a volume measuring device; a temperature sensor coupled to the container; and a pressure sensor coupled to the container. The heat transfer fluid can include water. The displaced volume gauge can include a volume gauge reservoir fluidly coupled to the measurement tower and an amount measurement device for measuring the amount of the heat transfer fluid in the volume gauge reservoir; the amount measurement device can include a load cell for measuring the weight of heat transfer fluid in the volume gauge reservoir. The volume gauge reservoir can be fluidly coupled to a reservoir shut-off valve; the reservoir shut-off valve can be fluidly coupled to the measurement tower. The temperature sensor can include a container temperature probe, and the pressure sensor can include a pressure transducer.

The test device can include the following: a tower supply valve, also referred to herein as a fluid bath supply valve, fluidly coupled to the fluid bath or measurement tower; a heat transfer fluid supply unit; a tower drain valve, also referred to herein as a fluid bath drain valve, fluidly coupled to the fluid bath or measurement tower; and a heat transfer fluid drain unit. The tower supply valve can be fluidly coupled to the heat transfer fluid supply unit, and the tower drain valve can be fluidly coupled to the heat transfer fluid drain unit. The test device can include the following: a tower vent fluidly coupled to the measurement tower; a tower vent drain, also referred to herein as a fluid bath vent drain; and a tower vent valve fluidly coupled to the tower vent and to the tower vent drain. The test device can also include a package vent fluidly coupled to the container, and a package vent valve fluidly coupled to the package vent and to the tower vent drain.

The test device can include a tower pressure gas supply and a tower pressure regulator fluidly coupled to the tower pressure gas supply. The tower vent can be fluidly coupled to the tower pressure regulator.

The test device can include components for controlling a temperature of the heat transfer fluid in the measurement tower. These components can include the following: a tower heater/cooler, also referred to herein as a fluid bath heater/cooler, coupled to the heat transfer fluid in the measurement tower or the fluid bath; a tower temperature probe, also referred to herein as a fluid bath temperature probe, for measuring the temperature of the heat transfer fluid in the measurement tower or the fluid bath; and a thermostat coupled to the tower heater/cooler and coupled to the tower temperature probe. The tower heater/cooler can include a heating/cooling coil in contact with the heat transfer fluid or in contact with the measurement tower or fluid bath, a first valve fluidly coupled to a hot water supply and to the heating/cooling coil, and a second valve fluidly coupled to a cold water supply and to the heating/cooling coil. The tower heater/cooler can further include a first solenoid capable of positioning, for example, capable of opening and closing, the first valve and a second solenoid capable of positioning, for example, opening and closing, the second valve, with the first solenoid and the second solenoid coupled to the thermostat. The tower heater/cooler can include a mixing chamber fluidly coupled to the heating/cooling coil and fluidly coupled to the first valve and to the second valve. The tower heater/cooler can include a mixing chamber temperature probe, for measuring a temperature of water in the mixing chamber, coupled to the thermostat. The test device can include a circulation pump fluidly coupled to the measurement tower; the circulation pump can circulate the heat transfer fluid in the measurement tower in order to promote a uniform temperature distribution in the measurement tower. The test device can further include a fill supply unit capable of holding a test substance and fluidly coupled to a fill valve, the fill valve fluidly coupled to the container, and a fill supply temperature regulating device capable of regulating the temperature of a test substance in the fill supply unit.

In another embodiment, the test device includes a response output unit, which is coupled to the displaced volume gauge and is capable of providing actual response data, for example, data on the change in interior volume of the container, and includes a test condition output unit, which is coupled to the temperature sensor and to the pressure sensor and is capable of providing test condition data. The response output unit can provide actual response data in an electronic form or in a visual form, and the test condition output unit can provide test condition data in an electronic form or a visual form. The test device can include a computer system having at least one processor, which can receive the actual response data and the test condition data; the computer system can be coupled to the response output unit and to the test condition output unit.

Tower temperature set point information can be used by the thermostat to direct the positioning of the first and second valves in order to have the temperature of the heat transfer fluid in the measurement tower approach the tower temperature set point. The at least one processor of the computer system can receive tower temperature set point information, for example, from a user or from a storage device. The computer system can be coupled to the thermostat, and the thermostat can receive tower temperature set point information transmitted by, for example, the computer system.

The computer system can receive information on the duration of heating or cooling a test substance in a container and the final temperature which the test substance in the container should reach. The computer system can be adapted to perform a method including calculating tower temperature set point as a function of time data, and to provide tower temperature set point as a function of time data to the thermostat. A machine-accessible medium can contain test device software code that can cause the computer system to perform the method, and can cause the computer system to provide the tower temperature set point as a function of time data to the thermostat.

The computer system can include a machine-accessible medium containing test device software code that, when executed by the at least one processor, causes the computer system to perform a method for reformatting and presenting actual response data and test condition data. The method can include reformatting the actual response data provided by the response output unit and the test condition data provided by the test condition output unit, and presenting the reformatted actual response data and the reformatted test condition data.

A method can include the following steps. A test device according to the invention including a fluid bath or a measurement tower holding a heat transfer fluid can be provided. The container can be immersed in the heat transfer fluid in the fluid bath or measurement tower; the container can be filled with a test substance; the temperature and/or the pressure of the heat transfer fluid in the measurement tower can be maintained or adjusted; an interior pressure in the container can be maintained, adjusted or allowed to vary; a change in the interior volume of the container can be measured; and an interior temperature and an interior pressure in the container can be measured.

The step of immersing the container in the heat transfer fluid in the fluid bath or measurement tower can itself include the following steps. The test device can include a measurement tower lid, and the container can be attached to the measurement tower lid. The tower vent valve can be opened; and the measurement tower lid can be attached onto the measurement tower. The tower supply valve can be opened to fluidly couple the heat transfer fluid supply unit and the measurement tower to allow heat transfer fluid to fill the measurement tower. The tower supply valve can be closed when the measurement tower is completely filled with heat transfer fluid such that substantially no air is present in the measurement tower. Alternatively, the tower supply valve can be closed before the measurement tower is completely filled with heat transfer fluid such that air is present in the measurement tower. The tower vent valve can be closed. The circulation pump can be activated.

The step of filling the container with a test substance can itself include the following steps. The package vent valve can be opened. The fill valve can be opened to allow the test substance to flow into the container, and the fill valve can be closed when a pre-determined level of the test substance in the container, a pre-determined interior temperature of the container, and/or a pre-determined differential between the internal pressure within the container and the ambient pressure around the container is reached. The package vent valve can be closed. The method can include the step of extracting a quantity of the test substance from or adding or filling a quantity of the test substance into the container with an extractor/filler fluidly coupled to the container. The steps of controlling the temperature and the pressure of the heat transfer fluid in the measurement tower can themselves include the following steps. The temperature of the heat transfer fluid in the measurement tower can be controlled by adjusting or maintaining the temperature of a tower heater/cooler coupled to the heat transfer fluid in the measurement tower. The pressure of the heat transfer fluid in the measurement tower can be controlled by adjusting or maintaining the setting of a tower pressure regulator fluidly coupled to a tower pressure gas supply and fluidly coupled to the tower vent.

The steps of measuring a change in interior volume of the container and measuring an interior temperature and an interior pressure in the container can themselves include the following steps. Actual response data, which can be representative of a measured change in interior volume of the container, can be outputted; test condition data, which can be representative of a measured interior temperature and a measured interior pressure of the container, can be outputted.

The method can further include the following steps. Measured change in interior volume of the container data and test condition data, for example, the measured interior temperature in the container and the measured interior pressure in the container, can be provided to a computer system having at least one processor. A machine-accessible medium can be provided, which contains test device software code that, when executed by the at least one processor, causes the computer system to reformat the measured change in interior volume of the container data and test condition data and to present the measured change in interior volume of the container data and test condition data. Data storage, for example, a data storage device, coupled to the computer system can be provided, and actual response data, for example, the measured change in interior volume of the container, and test condition data can be stored.

Actuation of a valve or valves in the system can be automatic. A solenoid or solenoids can be used to actuate the valve or valves, and the solenoid or solenoids can be controlled by a processor, e.g., a programmable logic controller. Automated actuation of a valve or valves can allow, for example, automated filling of the container with a test substance until a pre-determined interior temperature of the container, a pre-determined differential between the internal pressure within the container and the ambient pressure around the container, and/or a pre-determined level of the test substance in the container is reached. The solenoid or solenoids can be controlled by the computer system. Steps of preparing for a test, e.g., filling the container with the test substance, and steps of presenting and/or recording the measured change in interior volume of the container data and test condition data can be controlled by the computer system in an integrated manner.

The method can further include the following steps. Container parameter data and test condition data can be provided to a computer system. The computer system can have at least one processor. A machine-accessible medium can be provided that contains response prediction software code that, when executed by the at least one processor of the computer system, causes the computer system to predict the response of the container. Predicting the response can include, for example, predicting a change in the shape of the container or predicting a change in interior volume of the container.

The predicted response of the container can be compared with the actual response of the container, for example, the measured change in interior volume of the container, to determine whether the accuracy of the predicted response of the container is within a predetermined tolerance of the actual response of the container. The actual response of the container can include, for example, a change in the shape of the container or a change in interior volume of the container. The response prediction software code can cause the computer system to present the predicted response. Presenting the predicted response can include, for example, presenting a predicted change in the shape of the container or presenting a predicted change in interior volume of the container.

A method can include the following steps. Test condition data and measured change in interior volume of the container data can be generated through at least one trial of at least one container with the test device. A set of trial data can be composed from container parameter data for the at least one container, the test condition data, and the measured change in interior volume of the container data. The set of trial data can be provided to a computer system having at least one processor. A machine-accessible medium can be provided that contains trial data set response prediction software code that, when executed by the at least one processor, causes the computer system to apply finite element analysis to predict a change in interior volume of the at least one container for the at least one trial.

The method can further include providing a machine-accessible medium that contains trial data set training software code that, when executed by the at least one processor, can cause the computer system to perform the following steps. The computer system can execute the trial data set response prediction software code with the at least one processor at least once. The trial data set response prediction software code can cause the computer system to predict a change in interior volume of the at least one container for the at least one trial. The computer system can compare the predicted change in interior volume of the at least one container with the measured change in interior volume of the container data for the at least one trial at least once. The computer system can train itself by using at least one comparison in order to improve the accuracy of the computer system in predicting the change in interior volume of the at least one container for the at least one trial when the at least one processor executes the trial data set response prediction software code.

A moveable distance measuring device is an example of a volume measuring device. The moveable distance measuring device can include, for example, an ultrasonic distance measuring device or a laser distance measuring device.

In an embodiment, the test device includes a moveable distance measuring device, a computer system having at least one processor, and a carriage with a positioning motor. The moveable distance measuring device can be connected to the carriage, and can include a distance output coupled to the computer system. The computer system can receive information from the distance output on the distance from the moveable distance measuring device to the container, and the computer system can be adapted to direct the movement of the positioning motor.

The computer system can include a machine-accessible medium containing distance measuring software code that, when executed by the at least one processor, causes the computer system to perform a measurement method. The method can include moving a moveable distance measuring device to a user specified point. The method can include acquiring information on the distance from the moveable distance measuring device at the user specified point to the container. The method can include including information on the distance from the moveable distance measuring device at the user specified point to the container in distance as a function of position data. The method can include repeatedly moving the moveable distance measuring device to a next user specified point, acquiring information on the distance from the moveable distance measuring device at the user specified point to the container, and including the information on the distance from the moveable distance measuring device at the user specified point to the container in distance as a function of position data until the moveable distance measuring device has been moved to all user specified points.

The computer system can include a machine-accessible medium containing volume calculating software code that, when executed by the at least one processor, causes the computer system to perform a method for calculation. The method can include using the distance as a function of position data to calculate an estimate of an interior volume of the container.

### BRIEF DESCRIPTION OF THE DRAWING

The FIGURE is a schematic of a test device according to the invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without parting from the spirit and scope of the invention. All references cited herein are incorporated by reference as if each had been individually incorporated.

In an embodiment, the test device can perform tests involving the variables of internal pressure in the container, internal temperature in the container, volume of test substance in the container, and the test substance in the container. Over the duration of a test, a user can control one or more of these variables, and observe the non-controlled variables. For example, a sealed container can be subjected to a test in which the temperature is changed. It is understood that the temperature change can result in a pressure change in the interior of the container, which can result in a change in the interior volume of the container. A pressure change can be imposed in the interior of the container by withdrawing or adding a gas such as air to the container. Alternatively, a test substance that is not a gas can be withdrawn from or added to the container to impose a pressure change in the interior of the container. The interior temperature, interior pressure, and interior volume of the container can be continuously measured and recorded over the period of the test. This embodiment of a test device of the present invention thereby overcomes a limitation of prior art test devices which only measure interior pressure and interior volume of the container after the container has been subjected to a test. As used herein, the term “measure” refers broadly to calculating a physical quantity from an observable, e.g., in inferring a change in interior volume of the container from a change in heat transfer fluid displaced by the container, as well as directly measuring an observable.

The test device according to the present invention allows for any test substance to be filled into the container: for example, a gas, a liquid, a solid, or any combination of these can be filled into the container. For example, a food or a beverage that is commercially packaged can be filled into the container. Changing the test substance can affect a response of the container to imposed test conditions. For example, certain foods contain entrained air or other gases, such as carbon dioxide. It is thought that if a container is filled with such a food, a decrease of the internal temperature of the container can result in a decrease in the pressure of the entrained air, and thus to a contraction of and decrease of interior volume of the container. By contrast, if a container is completely filled with a food that contains little or no entrained air, a decrease in temperature can result in little or no decrease in interior pressure in and interior volume of the container.

The test device according to the invention could, for example, be used to measure the change in internal pressure in and internal volume of a container filled with a test substance and subjected to a change in internal temperature in the container. The test could be repeated with several different test substances, and the data obtained used to create a library of measured responses for different test substances. An unknown test substance could be subjected to a test with the test device, and the observed response correlated with the responses of known substances in the library to help identify the unknown test substance.

An embodiment of a test device according to the invention is depicted in the FIGURE. A container 2 can be supported in a measurement tower 4, which is an example of a fluid bath, holding a heat transfer fluid 6. The heat transfer fluid 6 can be, for example, water. Alternatively, the heat transfer fluid 6 can be a hydrocarbon oil, a silicone oil, or any other fluid, especially a fluid that is safe to use, e.g., a fluid that is non-toxic and not easily ignited, does not readily gel, polymerize, or otherwise change state, has a sufficient thermal conductivity to allow for good heat transfer, and has a sufficiently low viscosity to allow for circulation and ease of handling.

A displaced volume gauge 8 can be fluidly coupled to the heat transfer fluid 6 in the measurement tower. A temperature sensor 32 and a pressure sensor 34 can be coupled to the container 2. An extractor/filler 12 can be coupled to the container 2. The extractor/filler 12 can be, for example, fluidly coupled through an extractor/filler valve to a vacuum line and/or to a source of test substance such as a fill supply unit.

The test device can include a heat transfer fluid supply unit and a heat transfer fluid drain unit. A tower supply valve can be fluidly coupled to the measurement tower and to the heat transfer fluid supply unit. A tower drain valve can be fluidly coupled to the measurement tower and to the heat transfer fluid drain unit. The tower supply valve can be opened to fluidly connect the heat transfer fluid supply unit and the measurement tower; fluid can then flow from the heat transfer fluid supply unit through the tower supply valve into the measurement tower. Alternatively, the tower drain valve can be opened to fluidly connect the heat transfer fluid drain unit and the measurement tower; fluid can then flow from the measurement tower through the tower drain valve into the heat transfer fluid drain unit.

A tower vent can be fluidly coupled to the measurement tower 4; a tower vent valve can be fluidly coupled to the tower vent. A tower vent drain, also referred to herein as a fluid bath vent drain, can be fluidly coupled to the tower vent valve. A package vent can be fluidly coupled to the container 2, a package vent valve can be fluidly coupled to the package vent. The tower vent drain can be fluidly coupled to the package vent valve.

A fill supply unit can hold a test substance. The fill supply unit can be fluidly coupled to a fill valve, and the fill valve can be fluidly coupled to the container 2. A fill supply temperature regulating device can be capable of regulating the temperature of the test substance in the fill supply unit.

The container 2 can be positioned within the measurement tower 4 with a measurement tower lid 30. The measurement tower lid 30 can be used in conjunction with a neck plate assembly. The neck plate assembly can be clamped around a neck of the container 2, and the neck plate assembly attached to the measurement tower lid 30. The measurement tower lid 30 can be mounted onto the measurement tower 4. The measurement tower lid 30 can be secured on the measurement tower by, for example, toggle clamps. In addition to positioning the container 2 within the measurement tower 4, the measurement tower lid 30 can serve, in conjunction with the neck plate assembly and the container 2, to form an airtight seal, isolating the interior of the measurement tower 4 from the environment.

A circulation pump can be fluidly coupled to the measurement tower 4. When operating, the circulation pump can promote even temperature of the heat transfer fluid 6 throughout the measurement tower 4 through forced convection. The circulation pump can be, for example, an adjustable flow pump that is submerged in the measurement tower 4. Such a circulation pump can be obtained, for example, from an aquarium supplier.

A tower heater/cooler 14, also referred to herein as a fluid bath heater/cooler, can either heat or cool the heat transfer fluid 6 in the measurement tower 4 or a fluid bath. A tower temperature probe 16, also referred to herein as a fluid bath temperature probe, can measure the temperature of the heat transfer fluid 6 in the measurement tower 4 or a fluid bath. The tower temperature probe can be, for example, a resistance temperature detector such as a platinum resistance thermometer, or a thermocouple, such as an 80PK-22 immersion temperature probe manufactured by Fluke Corporation of Everett, Wash. A thermostat 18, coupled to the tower heater/cooler 14 and the tower temperature probe 16, can adjust the temperature of the tower heater/cooler 14 to control the temperature of the heat transfer fluid 6 in the measurement tower 4. For example, a DLC 01001 Dual Loop Controller manufactured by Red Lion Controls of York, Pa. can be used as a thermostat. For example, the temperature of the heat transfer fluid 6 in the measurement tower 4 can be maintained at a constant value or the temperature of the heat transfer fluid 6 in the measurement tower 4 can be ramped to higher temperatures or to lower temperatures during a test.

In an embodiment, the tower heater/cooler 14 can include a heating/cooling coil. The heating/cooling coil can be in contact with the heat transfer fluid 6. Alternatively, the heating/cooling coil can be in contact with the measurement tower, for example, with the exterior of the measurement tower, or in contact with the fluid bath, for example, with the exterior of the fluid bath. A first valve can be fluidly coupled to a hot water supply and to the heating/cooling coil; a second valve can be fluidly coupled to a cold water supply and to the heating/cooling coil. The heating/cooling coil can be connected to a heating/cooling coil drain. A first solenoid can open and close the first valve; a second solenoid can open and close the second valve. A solenoid and a valve can be selected and configured so that they function together in an on/off mode; i.e., the solenoid can position the valve in a fully opened position or position the valve in a fully closed position. Alternatively, a solenoid and a valve can be selected and configured so that they function together in a continuous mode; i.e., the solenoid can position the valve in a fully opened position, a fully closed position, or any position intermediate between fully opened and fully closed. An example of a solenoid valve that can be used is an Easy Flow Solenoid Control Valve Type 6022/6023 manufactured by Burkert Fluid Control Systems of Irvine, Calif. The first and the second solenoids can be coupled to the thermostat 18, so that the thermostat 18 can actuate the first or the second solenoid and thereby cause hot or cold water to flow through the heating/cooling coil and thereby bring the heat transfer fluid 6 in the water tower 4 to a set point temperature. In an embodiment, a mixing chamber can be fluidly coupled to the first valve and to the second valve and can be fluidly coupled to the heating/cooling coil. A mixing chamber temperature probe can measure the temperature of the water in the mixing chamber and can be coupled to the thermostat 18. The mixing chamber temperature probe can be, for example, a resistance temperature detector such as a platinum resistance thermometer, or a thermocouple, such as an 80PK-22 immersion temperature probe manufactured by Fluke Corporation of Everett, Wash. For example, the thermostat 18 can be provided with mixing chamber temperature set point information in conjunction with input from the mixing chamber temperature probe. The thermostat 18 can use the mixing chamber temperature set point information and the mixing chamber temperature probe information to direct the positioning of the first and second valves in order to have the temperature of the heat transfer fluid 6 in the mixing chamber approach the mixing chamber temperature set point. For example, the thermostat 18 can be provided with tower temperature set point information in conjunction with input from the tower temperature probe 16. The thermostat 18 can use the tower temperature set point information and tower temperature probe 16 input to direct the positioning of the first and second valves in order to have the temperature of the heat transfer fluid 6 in the measurement tower 4 approach the tower temperature set point. For example, the thermostat 18 can be provided with tower temperature set point information in conjunction with input from the tower temperature probe 16 and input from the mixing chamber temperature probe. The thermostat 18 can use the tower temperature set point information, the tower temperature probe 16 input, and the mixing chamber temperature probe input to direct the positioning of the first and second valves in order to have the temperature of the heat transfer fluid 6 in the measurement tower 4 approach the tower temperature set point.

The thermostat 18 can provide tower temperature data and mixing chamber temperature data in an electronic or in a visual form. Tower temperature data and mixing chamber temperature data can be transmitted to another device, for example, to a computer system 24. Tower temperature data and mixing chamber temperature data in a visual form can be observed by a user of the test device, can be manually recorded by a user, or can be manually entered by user through a keyboard or other input device into a computer system 24. Throughout this application, the term “recording” is used to refer to any form of data storage, e.g., electronic data storage, as well as manual recordation by a user. The thermostat 18 can receive tower temperature set point information through, for example, manual entry into a keypad, or in an electronic form, transmitted by another device, for example, a computer system 24.

A response output unit 20 can be coupled to the displaced volume gauge 8. The response output unit 20 can be capable of providing actual response data in an electronic form or in a visual form. A test condition output unit 22 can be coupled to the temperature sensor 32 and to the pressure sensor 34 and can be capable of providing test condition data in an electronic form or in a visual form. Actual response data or test condition data in an electronic form can be transmitted to another device, for example, to a computer system 24. Data in a visual form can be observed by a user of the test device during, say, range-finding experiments, can be manually recorded by a user, or can be manually entered by a user through a keyboard or other input device into a computer system 24.

An example of a temperature sensor 32 is a thermometer and an example of a pressure sensor 34 is a mechanical pressure gauge. The portion of the test condition output unit pertaining to the thermometer can then be the fluid level in the thermometer in conjunction with a graduated thermometer scale; the fluid level can be manually read by a user. The portion of the test condition output unit pertaining to the mechanical pressure gauge can then be a gauge needle in conjunction with a graduated scale on a gauge dial; the needle position can be manually read by a user. Another example of a temperature sensor 32 is a thermometer, and another example of a pressure sensor 34 is a manometer. The portion of the test condition output unit pertaining to the manometer can then be the fluid level in the manometer in conjunction with the manometer scale; the fluid level can be manually read by a user. Alternatively, the temperature sensor 32 can include a container temperature probe, and the pressure sensor 34 can include a pressure transducer, for example, a −15 psig to +15 psig Model 2200 pressure transducer manufactured by Gems Sensors of Basingstoke, United Kingdom. The container temperature probe can be, for example, a resistance temperature detector such as a platinum resistance thermometer, or a thermocouple, such as an 80PK-22 immersion temperature probe manufactured by Fluke Corporation of Everett, Wash. An example of a test condition output unit 22 is an analog-to-digital converter which converts the analog electrical signals of the container temperature probe and of the pressure transducer to a digital form, for example, a Model DLC (Dual Loop Controller) unit manufactured by Red Lion Controls of York, Pa. The signals having a digital form can be transmitted to another device, such as a computer system 24, or to a visual display, which a user can read.

An example of a displaced volume gauge 8 is a graduated pipette fluidly connected to the heat transfer fluid 6 in the measurement tower. The response output unit 20 is then the fluid level in the pipette in conjunction with the pipette scale; the level can be manually read by a user. Alternatively, the displaced volume gauge 8 can include a volume gauge reservoir, which can contain heat transfer fluid 6, fluidly coupled to the measurement tower 4. If the interior volume of a container 2, immersed in heat transfer fluid 6 in the measurement tower 4, decreases, heat transfer fluid 6 can flow from the volume gauge reservoir into the measurement tower 4 to fill the volume no longer occupied by the container 2, which has contracted in exterior as well as interior volume. Analogously, if the interior volume of a container 2, immersed in heat transfer fluid 6 in the measurement tower 4, increases, heat transfer fluid 6 can flow from the measurement tower 4 into the volume gauge reservoir to allow for the additional volume occupied by the container 2, which has expanded in exterior as well as interior volume. For example, a siphon can fluidly couple the volume gauge reservoir to the measurement tower 4. The volume gauge reservoir can be coupled to a reservoir shut-off valve; the reservoir shut-off valve can be coupled to the measurement tower 4, for example, coupled by a siphon. The reservoir shut-off valve can be closed to isolate the volume gauge reservoir from the measurement tower 4, for example, while the measurement tower 4 is being filled or drained of the heat transfer fluid 6.

The displaced volume gauge 8 can further include an amount measurement device for measuring the amount of heat transfer fluid in the volume gauge reservoir. For example, an amount measurement device can include an electronic scale, such as an Explorer electronic scale manufactured by Ohaus of Pine Brook, N.J., on which the volume gauge reservoir is placed. As the level of the heat transfer fluid 6 in the measurement tower 4 changes, the level of the heat transfer fluid 6 in the volume gauge reservoir changes so that the weight detected by the electronic scale changes. The response output unit 20 can be part of the electronic scale. For example, the electronic scale can transmit weight data in a digital form to another device or to a display. For example, the Explorer electronic scale by Ohaus can display a detected weight and can transmit the data to another device via an RS232 port. Alternatively, the amount measurement scale can include a load cell, the force sensor of which is connected to the volume gauge reservoir. The load cell output, representative of the weight of the heat transfer fluid in the volume gauge reservoir, can be detected by a response output unit 20, such as an IAMS unit manufactured by Red Lion Controls of York, Pa. The IAMS unit can convert the analog signals generated by the load cell to digital signals, and transmit these signals to, for example, another device or to a display, which a user can read. For example, the IAMS unit can transmit digital signals to a device such as a Model DLC (dual loop controller) unit; the Model DLC unit can then transmit digital signals to another device, such as a computer system 24. As another example, the IAMS unit can directly transmit digital signals to a computer system 24.

In an embodiment, the pressure of the heat transfer fluid 6 in the measurement tower 4 can be controlled. For example, the tower vent can be fluidly coupled to a tower pressure regulator; the tower pressure regulator can be fluidly coupled to a tower pressure gas supply. The tower pressure regulator can provide a gas, for example, air, at a controlled pressure to the measurement tower 4 to maintain or to change the pressure of the heat transfer fluid 6 in the measurement tower 4. A volume gauge reservoir can be isolated from the atmosphere and fluidly coupled to the tower pressure regulator, so that a gas provided at a controlled pressure from the tower pressure regulator to the volume gauge reservoir maintains the pressure of heat transfer fluid 6 in the volume gauge reservoir the same as the pressure of heat transfer fluid 6 in the measurement tower 4.

A computer system 24 having at least one processor, for example, a personal computer, can receive the actual response data from the response output unit 20 and the test condition data from the test condition output unit 22. The computer system 24 can be electronically coupled to the response output unit 20 and to the test condition output unit 22, so as to receive the actual response data in an analog or a digital electronic form and to receive the test condition data in an analog or a digital electronic form. The computer system 24 can be coupled to the thermostat 18 to receive tower temperature data or mixing chamber temperature data in an analog or a digital electronic form. A program, such as Modscan32 software written by WINPASO INC. of Ronceverte, W. Va., can be used to transform input to a computer system 24 into a data format useful within the computer system 24. Alternatively, a user can read the actual response data from a display of the response output unit 20, the test condition data from a display of the test condition output unit 22, or the tower temperature data or mixing chamber temperature data from a display of the thermostat 18, and input the actual response data and the test condition data into the computer system 24 manually, for example, through a keyboard.

The computer system 24 can also receive container parameter data through manual keyboard entry or in an electronic form, e.g., a transmitted data file. Container parameter data can include information such as a geometrical description of the interior and of the exterior surfaces of a container, mechanical properties associated with the material of which the container is formed, e.g., the modulus of elasticity and the yield stress, and thermo-mechanical properties, e.g., the effect of temperature on the modulus of elasticity. Data, for example, actual response data, test condition data, tower temperature data, mixing temperature data, and container parameter data can be stored. For example, the actual response data, test condition data, tower temperature data, mixing chamber temperature data, and container parameter data can be stored in a storage device 26. The data can be stored in, for example, a magnetic or an optical medium.

The computer system 24 can be adapted to reformat actual response data provided by the response output unit 20, either through an electronic couple or through manual input, and to reformat test condition data provided by the test condition output unit 22, either through an electronic couple or through manual input. The computer system 24 can be adapted to present the reformatted actual response data and the reformatted test condition data. The computer system 24 can be adapted to reformat tower temperature data or mixing chamber temperature data, and can be adapted to present the reformatted tower temperature data or the reformatted mixing chamber data. The data can, for example, be presented through a display, which can be read by a user, or be presented by transmitting the data in an analog or digital electronic form to another device. Throughout the text of this application, the terms “presenting” and “outputting” are used interchangeably. A machine-accessible medium, for example, a magnetic or an optical disk, can contain test device software code that, when executed by the at least one processor of a computer system 24, causes the computer system 24 to reformat and present actual response data, test condition data, tower temperature data, or mixing chamber data. An example of software that can reformat and present actual response data, test condition data, tower temperature data, or mixing chamber data is the CVC Datalogger program written by Graham Packaging Company L.P. of York, Pa. The CVC Datalogger program can direct a computer system 24 to further manipulate data processed by a computer system directed by a Modscan32 program.

The computer system 24 can be adapted to receive a tower temperature set point information from a user, e.g., through manual input through a keyboard or from a device such as a data storage device, and to provide the tower temperature set point data to the thermostat 18. The computer system 24 can be adapted to receive target temperature information on the target temperature of the heat transfer fluid 6 in the measurement tower 4, the rate at which a test substance in a container 2 should heat or cool, the duration of the heating or cooling of the test substance, and/or the final temperature which the test substance in the container 2 should reach from a user or a data storage device. The computer system 24 can be further adapted to receive, for example, heat parameter information on the specific heat capacity of the test substance, and receive heat transfer coefficient information for the container 2, test substance, and heat transfer fluid 6 from a user or a data storage device. The computer system 24 can be further adapted to receive tower temperature data and/or mixing chamber temperature data. The computer system 24 can be further adapted to calculate the tower temperature set point as a function of time from, for example, the target temperature information, heat parameter information, heat transfer coefficient information, and the tower temperature data and/or mixing chamber data. The calculated tower temperature set point as a function of time data is intended to achieve the target temperature of the heat transfer fluid 6 in the measurement tower 4, the specified rate at which a test substance in a container 2 should heat or cool, the duration of the heating or cooling of the test substance, and/or the final temperature which the test substance in the container 2 should reach. The computer system 24 can be adapted to provide the tower temperature set point as a function of time data to the thermostat 18. The receipt of target temperature information, heat parameter information, heat transfer coefficient information, and the tower temperature data and/or mixing chamber data, the calculation of the tower temperature set point as a function of time, and the provision of the tower temperature set point as a function of time data to the thermostat 18 can be directed by test device software code, such as the CVC Datalogger program. The computer system 24 can be adapted to provide the tower temperature set point as a function of time data to the thermostat 18 in an electronic form.

Alternatively, the computer system 24 can be further adapted to calculate the mixing chamber temperature set point as a function of time from, for example, the target temperature information, heat parameter information, heat transfer coefficient information, and the tower temperature data and/or mixing chamber temperature data. The calculated mixing chamber temperature set point as a function of time data is intended to achieve the target temperature of the heat transfer fluid 6 in the measurement tower 4, the specified rate at which a test substance in a container 2 should heat or cool, the duration of the heating or cooling of the test substance, and/or the final temperature which the test substance in the container 2 should reach. The computer system 24 can be adapted to provide the mixing chamber temperature set point as a function of time data to the thermostat 18. The receipt of target temperature information, heat parameter information, heat transfer coefficient information, and the tower temperature data and/or mixing chamber data, the calculation of the mixing chamber temperature set point as a function of time, and the provision of the mixing chamber temperature set point as a function of time data to the thermostat 18 can be directed by test device software code, such as the CVC Datalogger program. The computer system 24 can be adapted to provide the mixing chamber temperature set point as a function of time data to the thermostat 18 in an electronic form.

The test device software code can be contained on a machine-accessible medium, such as a magnetic disk or an optical disk.

The computer system 24 can be adapted to receive information on the interior temperature of the container 2, to recalculate the appropriate tower temperature set point as a function of time, and to provide the recalculated tower temperature set point data as a function of time to the thermostat 18. Alternatively, the computer system 24 can be adapted to receive information on the interior temperature of the container 2, to recalculate the appropriate mixing chamber temperature set point as a function of time, and to provide the recalculated mixing chamber temperature set point data as a function of time to the thermostat 18. Recalculation can be directed by software such as the CVC Datalogger program.

The computer system 24 can be adapted to calibrate a test condition output unit 22, e.g., a Model DLC unit, and a response output unit 20, e.g., an IAMS unit. A machine-accessible medium can contain calibration software code that, when executed by at least one processor of the computer system 24, causes the computer system 24 to calibrate a test condition output unit 22 and a response output unit 20. An example of such calibration software code is the RLC Pro program produced by Redlion Controls of York, Pa.

A computer system can be adapted to receive test condition data obtained from a test device, receive container parameter data, and predict a change in the shape of a container 2 resulting from exposure of the container 2 and contents of the container 2 to a change in conditions such as temperature. A machine-accessible medium, for example, a magnetic or an optical disk, can contain response prediction software code that, when executed by at least one processor or a computer system 24, causes the at least one processor or the computer system 24 to receive test condition data, receive container parameter data, and predict a change in shape of a container 2. The section of the software code that causes the computer system 24 to predict a change in shape of a container 2 can include, for example, a finite element modeling routine.

In using the test device, the following approach can be used. The test substance in the fill supply unit can be heated to a predetermined temperature with the fill supply temperature regulation device. The tower drain valve can be opened to fluidly connect the measurement tower 4 and the heat transfer fluid drain unit, so that heat transfer fluid 6 in the measurement tower 4 flows to the heat transfer fluid drain unit. When the level of the heat transfer fluid 6 in the measurement tower 4 is below a port in the measurement tower 4 to which the volume gauge reservoir is fluidly coupled, the reservoir shut-off valve can be opened to allow fluid in the volume gauge reservoir to drain. The reservoir shut-off valve and the tower drain valve can be closed.

The container 2 can be positioned within the measurement tower 4. A neck plate assembly can be clamped around the neck of the container 2, and the neck plate assembly can be attached to the measurement tower lid 30. The tower vent valve and the package vent valve can be opened. The measurement tower lid 30 can be attached onto the measurement tower 4 by, for example, tightening toggle clamps.

The tower supply valve can be shunted to fluidly couple the measurement tower 4 and the heat transfer fluid supply unit, so that the heat transfer fluid 6 flows from the heat transfer fluid supply unit into the measurement tower 4. The tower supply valve can be closed. For example, the tower supply valve can be closed when the level of heat transfer fluid begins to approach the measurement tower lid 30. Although the tower vent valve can release air or heat transfer fluid 6 from the measurement tower 4, the tower vent valve may have a small inner diameter so that if the tower supply valve is not shut off before heat transfer fluid 6 overflows the measurement tower 4, through the tower vent valve, pressure can build inside the measurement tower 4, which can deform the container 2. Gradual closure of the tower supply valve before the heat transfer fluid 6 reaches the measurement tower lid 30 can prevent the heat transfer fluid 6 from imposing pressure on and deforming the container 2. The tower supply valve can be opened slightly and closed until all air in the measurement tower 4 has been displaced by heat transfer fluid 6. Alternatively, the tower supply valve can be closed such that air remains in the tower.

The tower vent valve can be closed. The reservoir shut-off valve can be opened, and the tower supply valve can be opened slightly and closed until the volume gauge reservoir is partially filled with heat transfer fluid 6, for example, three-eighths filled with heat transfer fluid 6, and air has been removed from any line, e.g., a siphon, that fluidly connects the volume gauge reservoir and the measurement tower 4.

The fill valve can be opened to allow the test substance to flow into the container. The fill valve can be closed, for example, when a pre-determined level of the test substance in the container 2 or a pre-determined interior temperature of the container 2 is reached. The package vent valve can be closed. The circulation pump can be activated in order to circulate heat transfer fluid 6 in the measurement tower 4. A user of the test device can designate the start of the test, for example, at the time when a pre-determined level of test substance in the container 2 is reached, when a pre-determined interior temperature of the container 2 is reached, or when the package vent valve is closed. It is understood that if the temperature of a gas or another material, such as a liquid or a solid, that has a temperature dependent volume decreases during the test, for example, because heat flows from an interior of the container 2 to cooler heat transfer fluid 6 surrounding the container 2, the interior pressure of the container 2 can decrease. The decrease in interior pressure of the container 2 can cause a contraction of the container 2 and a decrease in interior volume of the container 2, and, in extreme cases, collapse of the container 2. Analogously, it is understood that if the temperature of gas or another material, such as a liquid or a solid, that has a temperature dependent volume in the container 2 increases during the test, for example, because heat flows from heat transfer fluid 6 surrounding the container 2 to a cooler interior of the container 2, the interior pressure of the container 2 can increase. The increase in interior pressure of the container 2 can cause an expansion of the container 2 and an increase in interior volume of the container 2, and, in extreme cases, bursting of the container 2.

For another type of test, an extractor/filler 12 can be fluidly coupled to the container 2 at a port of the extractor/filler 12. The extractor/filler 12 can be, for example, fluidly coupled through an extractor/filler valve to a vacuum line, to a pressurized gas line or to a source of test substance such as a fill supply unit. After the container 2 has been filled with an amount of test substance, and the fill valve and the package vent valve have been closed, the pressure at the port of the extractor/filler 12 can be reduced to a value less than the interior pressure of the container 2. Thereby, a test substance, air, a gas, or another material can be extracted from the interior of the container 2 and the interior pressure of the container 2 decreased. It is believed that a decrease in interior pressure of the container 2 can cause a contraction of the container 2 and a decrease in interior volume of the container 2. Alternatively, test substance, air, a gas, or another material can be provided at the port of the extractor/filler 12 at a pressure greater than the interior pressure of the container 2. Thereby, test substance, air, a gas, or another material can be filled into the interior of the container 2 and the interior pressure of the container 2 increased. It is understood that an increase in interior pressure of the container 2 can cause an expansion of the container 2 and an increase in interior volume of the container 2.

If the internal volume of the container 2 changes during the course of a test, the external volume of the container 2 is also expected to change. If no air is present in the measurement tower 4, and the external volume of the container 2 increases, the container 2 will displace more heat transfer fluid 6 from the measurement tower 4. The heat transfer fluid 6 can flow from the measurement tower 4 into, for example, a reservoir fluidly connected to the measurement tower 4. The increased volume of heat transfer fluid 6 in the reservoir can be detected as, for example, an increased weight of the reservoir by a load cell. The change in the volume of heat transfer fluid 6 in the reservoir can be determined, for example, by dividing the change in weight of the reservoir by the density of the heat transfer fluid 6. The change in external volume of the container 2 can then be assumed to be equal to the change in volume of heat transfer fluid 6 in the reservoir. The change in internal volume of the container 2 can be assumed to be the same as the change in external volume, or a correction can be applied to determine the change in internal volume from the change in external volume. Analogously, if no air is present in the measurement tower 4, and the internal volume of the container 2 decreases, the container 2 will displace less heat transfer fluid 6 from the measurement tower 4. A volume of heat transfer fluid 6 equal to the decrease in external volume of the container 2 is thought to flow from the reservoir into the measurement tower 4. The decreased volume of heat transfer fluid 6 in the reservoir can then be detected as, for example, a decreased weight of the reservoir, and the change in external volume of the container 2 can be calculated. The change in internal volume of the container 2 can be calculated from the change in external volume.

If air is present in the measurement tower 4, and the heat transfer fluid 6 in the measurement tower 4 is fluidly connected to the heat transfer fluid 6 in the reservoir, the change in the external volume of the container 2 can be calculated from the change in the weight of the reservoir associated with a change in the volume of heat transfer fluid 6 in the reservoir. If the pressure of the air in the measurement tower 4 is the same as the pressure of the air in the reservoir, because, for example, the tower vent is open to the atmosphere and the reservoir is open to the atmosphere, the change in volume of the container 2 can be calculated from Eq. 1.
ΔV_{C}=ΔV_{R}(A_{T}/A_{R}+1) Eq. 1

In Eq. 1, ΔV_{C} represents the change in external volume of the container 2, ΔV_{R} presents the change in the volume of heat transfer fluid 6 in the reservoir, A_{T} represents the area of the surface of the heat transfer fluid 6 in the measurement tower 4, and AR represents the area of the surface of the heat transfer fluid 6 in the reservoir. Eq. 1 is believed to hold if each of the measurement tower 4 and the reservoir have parallel sides, such as the form of a cylinder or a parallelepiped. A suitable relation between the change of volume of heat transfer fluid 6 in the reservoir and the change in external volume of the container 2 for the case in which the measurement tower 4 or the reservoir does not have parallel sides can be determined by one skilled in the art of mechanics or hydraulics. A suitable relation between the change of volume of heat transfer fluid 6 in the reservoir and the change in external volume of the container 2 for the case in which the pressure of air in the reservoir and the pressure of air in the measurement tower 4 are not the same can be determined by one skilled in the art of mechanics or in the art of hydraulics.

All valving in the test device according to the present invention can be automated. For example, each valve can have an associated solenoid. A solenoid and a valve can be selected and configured so that they function together in an on/off mode; i.e., the solenoid can position the valve in a fully opened position or position the valve in a fully closed position. Alternatively, a solenoid and a valve can be selected and configured so that they function together in a continuous mode; i.e., the solenoid can position the valve in a fully opened position, a fully closed position, or any position intermediate between fully opened and fully closed. Similarly, operation of other machinery in the test device can be automated; for example, the circulation pump can be operated by an automatic switch, such as a mechanical relay, solid state relay, or power transistor. Solenoids and automatic switches can be actuated by a processor, such as in a programmable logic controller. Automated control of valving and other machinery can be advantageous in reducing the amount of user time or level of user skill required for the performance of a test, and can improve the reproducibility of tests. For example, the interior temperature and interior pressure in a container 2, the volume of a test substance in the container 2, and the temperature of heat transfer fluid 6 in a measurement tower 4 can be controlled through automation of valving. The CVC DataLogger program can be executed by the processor, and the CVC DataLogger program can be configured to control actuation of solenoids or automatic switches. For example, a processor executing the CVC DataLogger program could actuate solenoids and automatic switches. Alternatively, a processor executing the CVC DataLogger program could provide instructions to a programmable logic controller coupled to solenoids or automatic switches. By using the CVC DataLogger program to control actuation of solenoids or automatic switches, the control of operation of the test device, the performance of a test, and the acquisition and processing of data from a test can be integrated.

Actual response data, representative of a measured change in the interior volume of the container, can be outputted. For example, the load cell can measure the weight of heat transfer fluid 6 in the volume gauge reservoir, and provide an analog signal representative of this weight to the IAMS unit. The transfer of heat transfer fluid 6 from the volume gauge reservoir into the measurement tower 4 or from the measurement tower 4 into the volume gauge reservoir is related to the change in the exterior volume of the container, and can be nearly equivalent to the change in the exterior volume of the container. The change in the exterior volume of the container can be nearly equivalent to the change in the interior volume of the container, so that the change in weight of heat transfer fluid 6 in the volume gauge reservoir divided by the density of the heat transfer fluid can be nearly equivalent to the change in the interior volume of the container. The IAMS unit can, for example, transmit digital signals representative of the weight to a Model DLC unit or to another device, such as a computer system 24. Alternatively, actual response data could be transmitted directly to a computer system 24; if the actual response data is in analog format, for example, an analog-to-digital converter board in the computer could accept the response data and convert it to a digital form acceptable by other components of the computer system 24.

Test condition data, representative of a measured interior temperature of the container 2 and a measured interior pressure in the container 2 can be outputted. For example, the container temperature probe can measure the interior temperature of the container 2 and provide an analog signal representative of this temperature to the Model DLC unit; the pressure transducer can measure the pressure in the interior of the container 2 and provide an analog signal representative of this pressure to the Model DLC unit. The Model DLC unit can, for example, transmit digital signals representative of the interior temperature of the container to another device, such as a computer system 24. Alternatively, test condition data could be transmitted directly to a computer system 24; if the test condition data is in analog format, for example, an analog-to-digital converter board in the computer could accept the response data and convert it to a digital form acceptable by other components of the computer system 24.

Actual response data and test condition data can be provided to a computer system 24 having at least one processor. A machine-accessible medium containing test device software code can be executed by the at least one processor to cause the computer system 24 to reformat the actual response data and the test condition data and to present the actual response data and test condition data. The actual response data and test condition data can be presented through an image on a video display terminal, or can be presented in that the data are outputted to another device.

For example, the CVC DataLogger program can be executed by the at least one processor. A user can direct the CVC DataLogger program to start acquiring data at any time. In this manner, the user can designate the time of the start of the test of a container 2, for example, at the time the test substance has reached a pre-determined level in the container 2. The CVC Datalogger program can start execution of the Modscan32 program. The Modscan32 program can receive actual response data from a response output unit 20, such as an IAMS unit in conjunction with a Model DLC unit, and test condition data from a test condition output unit 22, such as a Model DLC unit. The Modscan32 program can transform the data into a format which can be further manipulated by the CVC Datalogger program.

For example, the CVC Datalogger program can calculate the change in interior volume of the container 2 at a given time from the change in weight of heat transfer fluid 6 in the volume gauge reservoir. The CVC Datalogger program can display manipulated data, for example, the interior pressure of the container 2, the interior temperature of the container 2, and the change in the internal volume of the container 2 at various times, in the form of a spreadsheet. The CVC Datalogger program can export this manipulated data to a Microsoft® Excel spreadsheet. The CVC Datalogger program can allow control of the data acquisition process; for example, a user can instruct the CVC Datalogger program to acquire data at specific time intervals. The user can direct the CVC Datalogger program to subtract the initial weight of heat transfer fluid 6 in the volume gauge reservoir from subsequent measured weights of heat transfer fluid 6 in the volume gauge reservoir, and thereby have the CVC Datalogger program calculate and present the change in interior volume of the container 2 from the initial interior volume over the course of a test. The user can direct the CVC Datalogger program to display data such as interior pressure of a container, interior temperature of a container, and change in interior volume of a container in any one of several units. For example, interior temperature can be displayed in units of Celsius, Fahrenheit, and Kelvin, and, for example, the actual response data deriving from a load cell measuring the weight of a reservoir can be displayed in volume units such as cubic centimeters or cubic inches. The user can instruct the CVC Datalogger program to display instant information such as time, pressure, temperature, and volume change at any time. The user can direct the CVC Datalogger program to stop data acquisition at any time.

The actual response data and test condition data, including the data concerning the interior pressure and interior temperature of a container, representing physical values throughout a test, as well as container parameter data for the test, can be stored. The data stored can be, for example, formatted data; for example, data can be exported by the CVC Datalogger program to a Microsoft® Excel spreadsheet and the data in the spreadsheet format can be stored. Any one of a number of data storage media can be used, including a magnetic disk and an optical disk.

The test device can be used in conjunction with a computer system capable of predicting the response of a container 2 to a test. The predicted response can include, for example, a prediction of a change of interior volume of a container 2 or a prediction of a change of shape of a container 2. The response that is predicted can be, for example, a response of a container 2 subjected to a change in interior temperature or pressure during a test. The computer system can have at least one processor and can be provided with container parameter data and test condition data, including, for example, the representation of the interior pressure and interior temperature of a container 2 at various times. A machine-accessible medium can contain response prediction software code that, when executed by the at least one processor of the computer system, causes the computer to predict a change in the interior volume of the container 2 and present the predicted change in the interior volume of the container. The prediction of the change in the interior volume of the container 2 can represent the change in the interior volume of the container 2 throughout the test. Such response prediction software code can incorporate, for example, a finite element routine. The computer system can present the predicted change in the interior volume of the container by, for example, displaying the predicted change on a video display terminal, outputting the predicted change to another device, or maintaining the predicted change within a memory of the computer system for additional data processing.

The predicted change in interior volume of a container 2 subjected to a change in interior temperature or interior pressure during a test can be compared with actual response data; the actual response data can have been obtained in a test the conditions of which were used by the response prediction software code to make the prediction. The comparison can be used to determine whether the predicted change in interior volume of the container is within a predetermined tolerance of the actual response data. Such a comparison can be performed by a computer system, which can have at least one processor, and can be provided with actual response data and a predicted change in the interior volume of the container 2. The computer system can determine a representative comparison value, which represents the degree of similarity between the predicted change in interior volume of the container and the actual response data, e.g., the measured change in interior volume data, and determine whether the representative comparison value is greater than, equal to, or less than a predetermined tolerance. The computer system can, for example, determine the representative comparison value as the absolute value of the difference between the predicted change in interior volume of the container 2 at the end of the test and the measured change in interior volume of the container 2 at the end of the test. The computer system can, for example, calculate the difference between the predicted change and the measured change in the interior volume of the container 2 and divide this difference by the measured change in interior volume of the container 2 for various times during a test to determine fractional deviations, take the absolute value of each fractional deviation, sum these absolute values, and divide this sum by the number of times during the test when the change in the interior volume of the container 2 was measured and used to determine a fractional deviation. The computer system can, for example, calculate the difference between the predicted change and the measured change in the interior volume of the container 2 and divide this difference by the measured change in the interior volume of the container 2 for various times during a test to obtain fractional deviations, and calculate the root mean square of the group of fractional deviations to obtain the representative comparison value.

Test condition data and actual response data can be generated through at least one trial of at least one container 2 with the test device. Trials can be performed, for example, with the same or different temperatures of the test substance, temperatures of the heat transfer fluid, pressures at the port of the extractor/filler 12, and durations for which the pressure at the port of the extractor/filler is less than or greater than the interior pressure of the container 2. The trials can be performed with the same container 2 or with different containers 2. A set of trial data can be composed from the actual response data and test condition data for each trial and the container parameter data for the container 2 in each trial. At least one processor in a computer system can execute a trial data set response prediction software code contained in a machine-accessible medium, which causes the computer system to predict the change in the interior volume of the container 2 in each trial. The trial data set response prediction software code can include, for example, a finite element analysis routine to enable the computer system to predict the change in the interior volume of the container 2.

A computer system can be provided with a set of trial data. At least one processor in the computer system can execute a trial data set training software code, which causes the computer system to execute the trial data set response prediction software code with the at least one processor, which in turn causes the computer system to predict the change in the interior volume of the at least one container 2 for the at least one trial at least once. The at least one processor can further execute trial data set comparison software to compare the predicted change in the interior volume of the container 2 with the actual response data, including the measured change in the interior volume of the container 2, in each trial. The at least one comparison, which can include at least one representative comparison value, can be used by the computer system when the at least one processor executes trial data set training software code, contained on a machine-accessible medium. The trial data set training software code can cause the computer system to train itself by using the comparison or comparisons, for example, the representative comparison values, to improve the accuracy of the computer system in predicting the change in the interior volume of the at least one container for the at least one trial when executing the trial data set training software code.

In the course of the training, for example, the computer system can adjust the mesh size used when executing a finite element analysis routine of the trial data set training software code, predict the change in the interior volume of the at least one container 2 for the at least one trial anew, and compare the predicted change in the interior volume of the container 2 with the actual response data, including the measured change in the interior volume of the container 2, in each trial. The at least one representative comparison value can be used to determine a trial data set representative comparison value by, for example, averaging the one or more representative comparison value or values or determining the root mean square of the one or more representative comparison value or values. If the trial data set training software code can use this information to continue adjusting the mesh size, and the trial data set representative comparison value is less than or equal to an afore-determined permissible deviation, the new mesh size can be used in the future when the computer system executes the trial data set response prediction software code to predicting the change in interior volume of a container 2. If the trial data set representative comparison value is smaller than a trial data set representative comparison value determined before the mesh size was altered, but the trial data set representative comparison value is greater than an afore-determined permissible deviation, the trial data set training software code can cause the computer system to adjust the mesh size again, predict the change in the interior volume of the at least one container 2 again, and determine the at least one representative comparison value and the trial data set representative comparison value again. If the trial data set representative comparison value is greater than or equal to a trial data set representative comparison value determined before the mesh size was altered, the trial data set training software code can cause the computer system to adjust other parameters, for example, to adjust values in the container parameter data or in the test condition data which may have been erroneously measured. The approach presented in this paragraph is an example; any one of or combination of iterative optimization techniques well-known in the art can be applied to train the computer system to more accurately predict a change in the interior volume of a container 2.

A moveable distance measuring device is an example of a volume measuring device. The moveable distance measuring device can include, for example, an ultrasonic distance measuring device or a laser distance measuring device.

In an embodiment, the test device includes a moveable distance measuring device, a computer system having at least one processor, and a carriage with a positioning motor. The moveable distance measuring device can be connected to the carriage, and can include a distance output coupled to the computer system. The test device can include a location unit for establishing the location of the carriage; the location unit can include a location output coupled to the computer system. For example, the location unit can include an encoder coupled to the positioning motor; the encoder can provide information to the computer system through the location output useful in establishing the location of the carriage. The computer system can receive information from the distance output on the distance from the moveable distance measuring device to the container 2. The computer system can receive information from the location output on the location of the carriage. The computer system can be adapted to direct the movement of the positioning motor.

In an embodiment, the moveable distance measuring device can move along a track which the test device includes. For example, the moveable distance measuring device can be connected to the carriage, and the carriage can move along the track. For example, the positioning motor can be a rotary electromagnetic motor connected to wheels of the carriage, and the wheels can contact rails which form the track. As another example, the positioning motor can be a linear electromagnetic motor, which moves over permanent magnets or electromagnets which form the track. The positioning motor can be a stepper motor. The track can, for example, be mounted on the interior or exterior surface of the fluid bath. For example, the test device can include a track mounted inside the fluid bath. The carriage and moveable distance measuring device can be submerged in the heat transfer fluid.

The track can, for example, be mounted so that the moveable distance measuring device travels in a plane which is perpendicular to the longitudinal axis of the container 2. For example, the fluid bath can have the form of a cylinder, and the track can be mounted on the interior wall of the fluid bath so that the track forms a closed loop lying in a plane which is perpendicular to the longitudinal axis of the fluid bath or perpendicular to the longitudinal axis of the container 2. As another example, the track can be mounted so that the moveable distance measuring device travels in a direction parallel to the longitudinal axis of the container 2. The track can also be mounted in other configurations, for example, the track can be mounted in a helical configuration, so that as the carriage moves along the track, the carriage simultaneously moves circumferentially around the longitudinal axis of the cylinder and in a direction parallel to the longitudinal axis of the cylinder.

In an embodiment, a first track can be mounted on the fluid bath, a first carriage can be guided by the first track, a second track can be mounted on the first carriage, a second carriage can be guided by the second track, and the moveable distance measuring device can be connected to the second carriage. For example, the first track can be mounted on the interior wall of the fluid bath so that the track forms a closed loop lying in a plane which is perpendicular to the longitudinal axis of the container 2. The second track can mounted on the first carriage so that the second carriage can move in a direction parallel to the longitudinal axis of the container 2. The second track can be formed and mounted so that the second carriage can move in a straight line. Or, the second track can formed as a curve, and, for example, mounted so that the second carriage moves radially inward toward the longitudinal axis of the container 2 as the second carriage moves downward away from the center of the container 2, and so that the second carriage moves radially inward as the second carriage moves upward away from the center of the container 2. Such a configuration of a first track and a second track can allow the moveable distance measuring device to determine the distance between it and a point on the exterior of the container 2, the point lying on a side wall, the bottom, or the top of the container 2.

In an embodiment, multiple tracks are mounted on the fluid bath. Each track can support a carriage with a connected moveable distance measuring device. For example, a track can be mounted on the side wall of a cylindrical fluid bath, and a track can be mounted on the bottom of the cylindrical fluid bath.

The computer system can include a machine-accessible medium containing distance measuring software code that, when executed by the at least one processor, causes the computer system to perform a measurement method. The method can include moving a moveable distance measuring device to a user specified point. The method can include acquiring information on the distance from the moveable distance measuring device at the user specified point to the container 2. The method can include including information on the distance from the moveable distance measuring device at the user specified point to the container 2 in distance as a function of position data. The method can include repeatedly moving the moveable distance measuring device to a next user specified point, acquiring information on the distance from the moveable distance measuring device at the user specified point to the container 2, and including the information on the distance from the moveable distance measuring device at the user specified point to the container 2 in distance as a function of position data until the moveable distance measuring device has been moved to all user specified points.

The computer system can include a machine-accessible medium containing volume calculating software code that, when executed by the at least one processor, causes the computer system to perform a method for calculation. The method can include using the distance as a function of position data to calculate an estimate of an interior volume of the container 2. For example, the method can include using the distance as a function of position data to determine the position in three-dimensional space of each point on the surface of the container 2 to which the moveable distance measuring device measured a distance. The method can interpolate the form of the surface between these points. The method can calculate an estimate of the interior volume of the container 2 from the interpolated surface of the container 2.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A test device for a container, comprising:
a fluid bath holding a heat transfer fluid;
a volume measuring device;
a temperature sensor coupled to the container; and
a pressure sensor coupled to the container.

2. The test device of claim 1, further comprising:
a package vent fluidly coupled to the container;
a fluid bath vent drain; and
a package vent valve fluidly coupled to said package vent and to said fluid bath vent drain.

3. The test device of claim 1, further comprising:
a fluid bath heater/cooler coupled to the heat transfer fluid in said fluid bath;
a fluid bath temperature probe for measuring a temperature of the heat transfer fluid in said fluid bath; and
a thermostat coupled to said fluid bath heater/cooler and said fluid bath temperature probe, for controlling the temperature of the heat transfer fluid in said fluid bath.

4. The test device of claim 3:
said fluid bath heater/cooler comprising
a heating/cooling coil in contact with the heat transfer fluid or in contact with said fluid bath,
a first valve fluidly coupled to a hot water supply and to said heating/cooling coil,
a second valve fluidly coupled to a cold water supply and to said heating/cooling coil,
a first solenoid capable of positioning said first valve,
a second solenoid capable of positioning said second valve,
said first solenoid and said second solenoid coupled to said thermostat.

5. The test device of claim 3:
said fluid bath heater/cooler comprising
a heating/cooling coil in contact with the heat transfer fluid or in contact with said fluid bath,
a mixing chamber fluidly coupled to said heating/cooling coil,
a first valve fluidly coupled to a hot water supply and to said mixing chamber,
a second valve fluidly coupled to a cold water supply and to said mixing chamber,
a mixing chamber temperature probe for measuring a temperature of water in said mixing chamber,
said mixing chamber temperature probe coupled to said thermostat,
a first solenoid capable of opening and closing said first valve,
a second solenoid capable of opening and closing said second valve,
said first solenoid and said second solenoid coupled to said thermostat.

6. The test device of claim 5, further comprising:
a computer system having at least one processor;
said computer system capable of receiving information on a duration of heating or cooling a test substance in a container and on a final temperature which the test substance in the container should reach;
said computer system adapted to perform a method comprising calculating tower temperature set point as a function of time data; and
said computer system adapted to provide the tower temperature set point as a function of time data to said thermostat, and
further comprising a machine-accessible medium containing test device software code that, when executed by said at least one processor, causes said computer system to perform said method and to provide the tower temperature set point as a function of time data to said thermostat.

7. The test device of claim 1,
said fluid bath comprising a measurement tower; and
said volume measuring device comprising a displaced volume gauge coupled to the heat transfer fluid in said measurement tower.

8. The test device of claim 7,
said displaced volume gauge comprising
a volume gauge reservoir fluidly coupled to said measurement tower and
an amount measurement device for measuring an amount of the heat transfer fluid in said volume gauge reservoir;
said temperature sensor comprising a container temperature probe; and
said pressure sensor comprising a pressure transducer.

9. The test device of claim 8, said amount measurement device comprising a load cell for measuring a weight of the heat transfer fluid in said volume gauge reservoir.

10. The test device of claim 7, further comprising
a tower pressure gas supply;
a tower pressure regulator fluidly coupled to said tower pressure gas supply; and
a tower vent fluidly coupled to said measurement tower;
said tower vent fluidly coupled to said tower pressure regulator.

11. The test device of claim 7, further comprising:
a response output unit coupled to said displaced volume gauge and capable of providing actual response data; and
a test condition output unit coupled to said temperature sensor and to said pressure sensor and capable of providing test condition data.

12. The test device of claim 11, further comprising a computer system having at least one processor, capable of receiving the actual response data and the test condition data.

13. The test device of claim 12:
said computer system adapted to perform a method comprising
reformatting the actual response data provided by said response output unit and the test condition data provided by said test condition output unit,
presenting the reformatted actual response data and the reformatted test condition data,
and further comprising a machine-accessible medium containing test device software code that, when executed by said at least one processor, causes said computer system to perform said method.

14. The test device of claim 7,
said displaced volume gauge comprising a volume gauge reservoir and a load cell for measuring a weight of the heat transfer fluid in said volume gauge reservoir;
said volume gauge reservoir fluidly coupled to a reservoir shut-off valve;
said reservoir shut-off valve fluidly coupled to said measurement tower;
said temperature sensor comprising a container temperature probe;
said pressure sensor comprising a pressure transducer;
and further comprising
a heat transfer fluid supply unit;
a heat transfer fluid drain unit;
a tower supply valve, fluidly coupled to said measurement tower and fluidly coupled to said heat transfer fluid supply unit,
a tower vent fluidly coupled to said measurement tower,
a tower vent drain,
a tower vent valve fluidly coupled to said tower vent and to said tower vent drain,
a measurement tower lid,
a circulation pump fluidly coupled to said measurement tower,
a package vent fluidly coupled to the container,
a fill supply unit holding a test substance and fluidly coupled to the container,
a fill supply temperature regulating device capable of regulating a temperature of the test substance in said fill supply unit,
a fill valve fluidly coupled to the container and to said fill supply unit,
a package vent valve fluidly coupled to said package vent and to said tower vent drain,
a response output unit coupled to said displaced volume gauge and capable of providing actual response data, said response output unit capable of providing the actual response data in an electronic form,
a test condition output unit coupled to said temperature sensor and to said pressure sensor and capable of providing test condition data, said test condition output unit capable of providing the test condition data in an electronic form,
a computer system having at least one processor, coupled to said response output unit and coupled to said test condition output unit,
said computer system capable of receiving the actual response data and the test condition data,
said computer system adapted to perform a method comprising
reformatting the actual response data provided by said response output unit and the test condition data provided by said test condition output unit,
presenting the reformatted actual response data and the reformatted test condition data,
a machine-accessible medium containing test device software code that, when executed by said at least one processor, causes said computer system to perform said method, and
a storage device, coupled to said computer system,
said storage device capable of storing the actual response data and the test condition data,
wherein the test condition data comprises data on the interior temperature of the container and on the interior pressure of the container and
wherein the actual response data comprises data on a change in interior volume of the container.

15. A system, comprising:
a computer system having at least one processor adapted to perform a method comprising
receiving test condition data obtained from said test device for a container of claim 1,
receiving container parameter data,
predicting a change in shape of the container and
said computer system comprising a machine-accessible medium containing response prediction software code that, when executed by said at least one processor, causes said computer system to perform said method.

16. A method, comprising the steps of:
providing a test device comprising a fluid bath holding a heat transfer fluid;
immersing a container in the heat transfer fluid in said fluid bath;
filling the container with a test substance;
measuring a change in interior volume of the container; and
measuring an interior temperature and an interior pressure in the container.

17. The method of claim 16,
wherein said fluid bath comprises a measurement tower, and
said step of immersing the container in the heat transfer fluid in said fluid bath comprising the steps of
attaching the container to a measurement tower lid,
opening a tower vent valve fluidly coupled to a tower vent drain and to a tower vent fluidly coupled to said measurement tower,
attaching said measurement tower lid onto said measurement tower,
opening a tower supply valve fluidly coupled to said measurement tower and to a heat transfer fluid supply unit, to allow heat transfer fluid to fill said measurement tower,
closing said tower supply valve,
closing said tower vent valve, and
activating a circulation pump fluidly coupled to said measurement tower.

18. The method of claim 17,
further comprising the step of controlling a pressure of the heat transfer fluid in said measurement tower by
providing a tower pressure gas supply,
providing a tower pressure regulator fluidly coupled to said tower pressure gas supply and fluidly coupled to said tower vent, and
adjusting or maintaining the setting of the tower pressure regulator.

19. The method of claim 16, further comprising the steps of:
providing a computer system having at least one processor;
providing the measured change in interior volume of the container, the measured interior temperature in the container, and the measured interior pressure in the container to said computer system;
providing a machine-accessible medium containing test device software code that, when executed by said at least one processor, causes said computer system to reformat the measured change in interior volume of the container, the measured interior temperature in the container, and the measured interior pressure in the container, and to present the measured change in interior volume of the container, the measured interior temperature in the container, and the measured interior pressure in the container.

20. The method of claim 16, further comprising the steps of:
filling a quantity of the test substance into the container with an extractor/filler fluidly coupled to the container; and
extracting a quantity of the test substance from the container with said extractor/filler.

21. The method of claim 16, further comprising the steps of:
providing a computer system having at least one processor;
providing container parameter data, the measured interior temperature in the container, and the measured interior pressure in the container to said computer system;
providing a machine-accessible medium containing response prediction software code that, when executed by said at least one processor, causes said computer system to predict a change in interior volume of the container and to present a predicted change in interior volume of the container; and
comparing the predicted change in interior volume of the container with the measured change in interior volume of the container to determine whether the accuracy of the predicted change in interior volume of the container is within a predetermined tolerance of the measured change in interior volume of the container.

22. A method, comprising the steps of:
providing a test device;
generating test condition data and measured change in interior volume of the container data through at least one trial of at least one container with said test device;
composing a set of trial data comprising container parameter data for the at least one container, the test condition data, and the measured change in interior volume of the container data;
providing the set of trial data to a computer system having at least one processor; and
providing a machine-accessible medium containing trial data set response prediction software code that, when executed by said at least one processor, causes said computer system to apply finite element analysis to predict a change in interior volume of the at least one container for the at least one trial.

23. The method of claim 22, further comprising the steps of:
providing a machine-accessible medium containing trial data set training software code that, when executed by said at least one processor, causes said computer system to
execute said trial data set response prediction software code with said at least one processor at least once,
compare the predicted change in interior volume of the at least one container with the measured change in interior volume of the container data for the at least one trial at least once, and
train said computer system by using at least one comparison in order to improve an accuracy of said computer system in predicting the change in interior volume of the at least one container for the at least one trial when said at least one processor executes the trial data set response prediction software code.

24. The test device of claim 1, said volume measuring device comprising a moveable distance measuring device.

25. The test device of claim 24, wherein said moveable distance measuring device is selected from the group consisting of an ultrasonic distance measuring device and a laser distance measuring device.

26. The test device of claim 24, further comprising:
a computer system having at least one processor; and
a carriage with a positioning motor,
wherein said moveable distance measuring device is connected to said carriage,
wherein said moveable distance measuring device comprises a distance output coupled to said computer system,
wherein said computer system is capable of receiving information from said distance output on the distance from said moveable distance measuring device to the container,
wherein said computer system is adapted to direct the movement of the positioning motor.

27. The test device of claim 26,
said computer system adapted to perform a measurement method comprising
a) moving said moveable distance measuring device to a user specified point,
b) acquiring information on the distance from said moveable distance measuring device at the user specified point to the container,
c) including the information on the distance from said moveable distance measuring device at the user specified point to the container in distance as a function of position data,
d) moving said moveable distance measuring device to a next user specified point and repeating b) and c) until said moveable distance measuring device has been moved to all user specified points, and
further comprising a machine-accessible medium containing distance measuring software code that, when executed by said at least one processor, causes said computer system to perform said measurement method.

28. The test device of claim 27,
said computer system further adapted to perform a calculation method comprising using the distance as a function of position data to calculate an estimate of an interior volume of the container, and
further comprising a machine-accessible medium containing volume calculating software code that, when executed by said at least one processor, causes said computer system to perform said calculation method.
